(19) United States
(12) Patent Application Publication
(10) Pub. No.: US 2025/0132878 A1
(43) Pub. Date: Apr. 24, 2025

(54) DYNAMIC ADJUSTMENT OF ADAPTIVE RECEPTION DIVERSITY

(71) Applicant: QUALCOMM Incorporated, San Diego, CA (US)

(72) Inventors: Yashesh ZAVERI, San Diego, CA (US); Neeraj PANWAR, San Diego, CA (US); Kumarabhijeet SINGH, San Diego, CA (US); Deepak VOMMI, San Marcos, CA (US); Venkata Siva Prasad Rao GUDE, San Diego, CA (US); Tejas Harekrishna SADARAHALLI, Poway, CA (US); Sunil BENGALURU RAVISHANKAR, San Diego, CA (US)

(21) Appl. No.: 18/491,124

(22) Filed: Oct. 20, 2023

(51) Int. Cl. H04L 5/00; H04L 5/14

(52) U.S. Cl. CPC H04L 5/0051; H04L 5/14

(57) ABSTRACT

Certain aspects of the present disclosure provide techniques for dynamic adjustment of adaptive reception diversity (ARD). An example method, performed at a user equipment (UE), generally includes receiving configuration information configuring the UE with first resources for receiving at least one downlink signal and second resources for transmitting at least one uplink signal, detecting a conflict between the first resources and the second resources, and dynamically adjusting an adaptive reception diversity (ARD) mode if one or more conditions are met after detecting the conflict.

### BACKGROUND

### Field of the Disclosure

Aspects of the present disclosure relate to wireless communications, and more particularly, to techniques for dynamic adjustment of adaptive reception diversity (ARD).

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communications at a user equipment (UE). The method includes receiving configuration information configuring the UE with first resources for receiving at least one downlink signal and second resources for transmitting at least one uplink signal; detecting a conflict between the first resources and the second resources; and dynamically adjusting an adaptive reception diversity (ARD) mode if one or more conditions are met after detecting the conflict.

Other aspects provide: an apparatus operable, configured, or otherwise adapted to perform any one or more of the aforementioned methods and/or those described elsewhere herein; a non-transitory, computer-readable media comprising instructions that, when executed by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 depicts an example of components capable of enabling antenna switch diversity (ASDIV).

FIG. 6 depicts an example diagram illustrating adaptive reception diversity (ARD).

FIGS. 7A and 7B illustrate an example conflict between resources allocated for uplink transmission and downlink reception, in accordance with certain aspects of the present disclosure.

FIG. 8 depicts a call flow diagram illustrating dynamic adjustment of ARD, in accordance with certain aspects of the present disclosure.

FIG. 9 depicts an example timing diagram illustrating dynamic adjustment of ARD, in accordance with certain aspects of the present disclosure.

FIG. 10 depicts a method for wireless communications.

FIG. 11 depicts aspects of an example communications device.

### DETAILED DESCRIPTION

Aspects of the present disclosure provide apparatuses, methods, processing systems, and computer-readable mediums for dynamic adjustment of adaptive reception diversity (ARD).

A Sounding Reference Signal (SRS) is a reference signal transmitted by a user equipment (UE) in the uplink direction which is used by a network entity (e.g., a gNodeB) to estimate the uplink channel quality over a wider bandwidth. As such, SRS transmissions are an integral part of modern wireless communication systems (e.g., 5G NR). SRS transmissions by a user equipment (UE), for example, may enable the network entity to adapt transmission parameters in an effort to optimize the performance of the communication link between the user equipment and the base station. This dynamic feedback mechanism helps ensure reliable and efficient wireless communication in various operating conditions.

Antenna switch diversity (ASDIV) generally refers to a mechanism that allows two or more antennas (e.g., antenna combinations) to form different input and output ports to establish different RF paths. For example, in multiple-input multiple-output (MIMO) or multi-transmission co-banded scenarios, ASDIV may allow a wireless node to simultaneously use two transmit antennas.

Adaptive Reception Diversity (ARD) is a technique used in wireless communications to improve the quality and reliability of radio signal reception in adverse conditions, particularly in the presence of fading and interference. ARD involves dynamically adjusting the reception parameters of a wireless receiver (e.g., based on current channel conditions) to optimize device performance and signal reception quality and reliability. For example, in some cases, ARD may involve dynamically transitioning between a four receive antenna/port (4Rx) mode, a three receive antenna/port (3Rx) mode, a two receive antenna/port (2Rx) mode, and a one receive antenna/port (1Rx) mode.

In certain scenarios involving downlink and uplink carrier aggregation (CA) (e.g., in the mid band frequency range), where frequency division duplexing (FDD) and time division duplexing (TDD) carriers share an antenna, TDD uplink sounding reference signal (SRS) transmission may cause problems for FDD downlink reception. To overcome these problems, a UE may disable ARD and implement dynamic rank capping and reception de-sensing. However, when ARD is disabled, the UE may never transition to a 2Rx mode (e.g., from a 4Rx mode), even when a greater quantity of receive antennas/ports is not beneficial (e.g., when only 2 receive antennas/ports are viable and/or when only 2 L downlink grants are configured for the FDD carrier). In other words, a UE may only have 2 viable receive antennas/ports (e.g., due to conflicts) or may only receive downlink grants to receive on 2 antennas/ports, but the UE may still have 4 active receive antennas/ports, leading to excessive power consumption/waste.

In some cases, the SRS configuration on the TDD carrier may be periodic, semi-persistent (e.g., the network may activate or deactivate dynamically), or aperiodic. Disabling ARD (e.g., statically) without considering SRS configuration may also lead to excessive power consumption/waste.

Certain aspects of the present disclosure provide techniques for dynamic adjustment of ARD. For example, in some aspects, a UE may detect a conflict between resources allocated for receiving downlink signals (e.g., PDSCH) and resources allocated for transmitting SRS. In such cases, ARD may be dynamically adjusted (e.g., enabled, disabled, or mode switched) based on impacted FDD receive ports and/or the configuration of SRS on a TDD carrier. Dynamically enabling/disabling ARD (allowing a UE to transition to 2Rx mode when appropriate) based on conflict/impact (or lack thereof) and/or SRS configuration may help to reduce power/energy consumption. The techniques disclosed herein may be particularly beneficial in multiple SIM (MSIM) scenarios, since power savings/gains may benefit each of the multiple SIMs (e.g., if they use higher order CA with TDD and FDD).

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

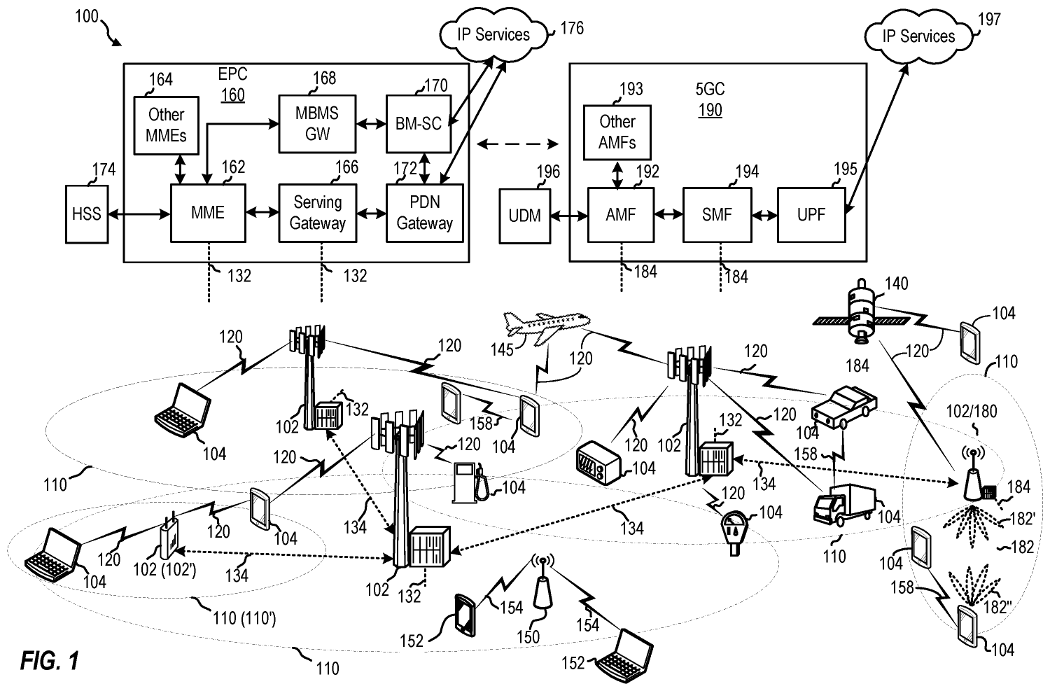

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

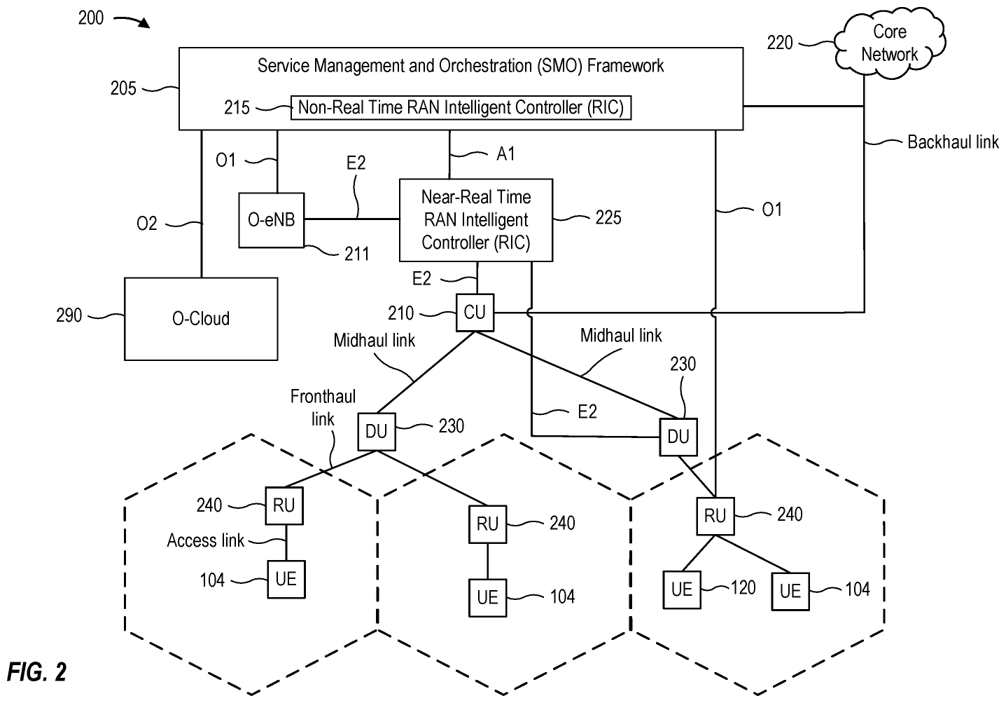

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHZ, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mm Wave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QOS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

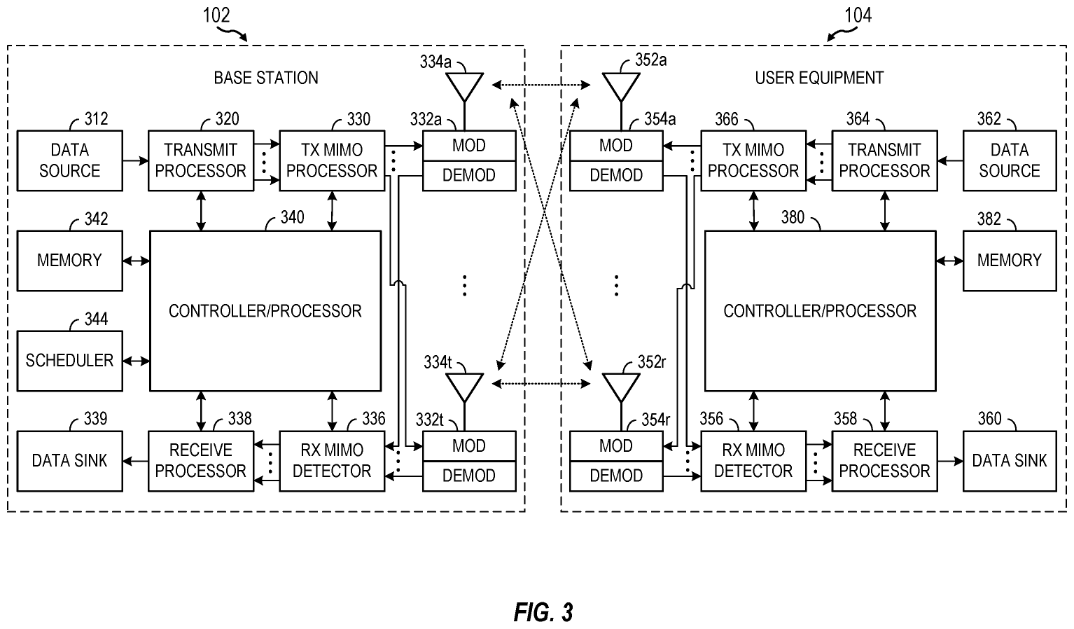

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, one or more processors may be configured to perform various operations, such as those associated with the methods described herein, and transmit (output) to or receive (obtain) data from another interface that is configured to transmit or receive, respectively, the data.

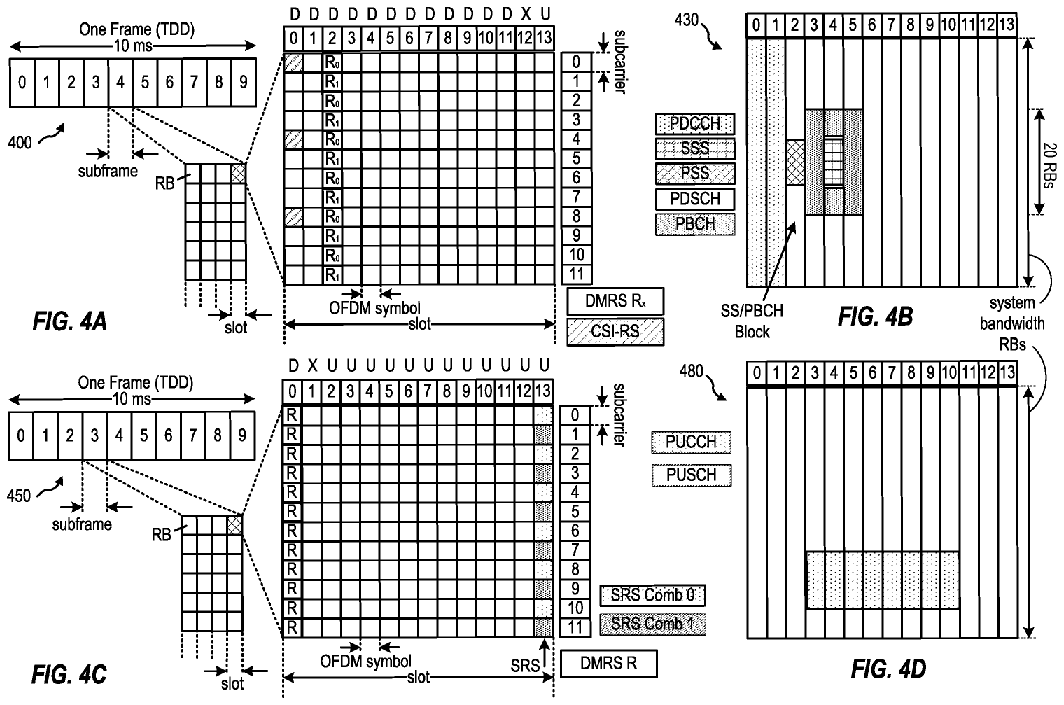

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where Dis DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 6 allow for 1, 2, 4, 8, 16, 32, and 64 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 24×15 kHz, where μ is the numerology 0 to 6. As such, the numerology μ=0 has a subcarrier spacing of 15 kHz and the numerology μ=6 has a subcarrier spacing of 960 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Overview of Sounding Reference Signal Usage

A SRS is Sounding Reference Signal is a reference signal transmitted by the UE in the uplink direction which is used by a network entity (e.g., a base station) to estimate the uplink channel quality over a wider bandwidth. SRS is a UL reference signal which is transmitted by UE to the base station. SRS measurements provide information about the combined effect of multipath fading, scattering, Doppler, and power loss of the transmitted signal. SRSs are employed by the UE for uplink channel sounding, including channel quality estimation and synchronization. Unlike Demodulation reference signals (DM-RS), SRS is not associated with any physical uplink channels and they support uplink channel-dependent scheduling and link adaptation.

The role of SRS may be considered as similar to the role of CSI-RS. CSI-RS is a reference signal for downlink channel quality estimation independent of PDSCH DMRS and SRS is a reference signal for uplink channel quality estimation independent of PUSCH DMRS. SRS may play an important role in systems, such as NR, where TDD is dominant mode of deployment. In TDD, a base station can utilize the channel estimation result from SRS not only for UL scheduling but also for DL scheduling as well based on channel reciprocity in TDD.

SRS may be configured for various use cases. Such use cases include codebook-based closed-loop spatial multiplexing, control uplink transmit timing, reciprocity-based downlink precoding in multi-user MIMO setups, and for Quasi co-location (QCL) of physical channels and reference signals.

A UE may be configured, via an RRC parameter, to perform SRS-based antenna switching. The UE may perform antenna switching in various ways, depending on the RRC parameter setting and UE capability. SRS for antenna switching may be transmitted on SRS resources that are part of a configured SRS resource set. Each Resource Set may have SRS resources transmitting at different symbols, depending on the configuration, with each SRS resource consisting of a single SRS port. The SRS configuration may be set for different types of antenna switching between different transmit and receive antenna configurations. A UE with 2 TX chains and 4 RX antenna ports (2T4R) may only need 2 SRS resources to transmit (“sound”) on all 4 antenna ports (with each SRS resource having two ports and each SRS port being associated with a different RX antenna port).

### Example Antenna Switch Diversity (ASDIV) and Radio Frequency (RF) Paths

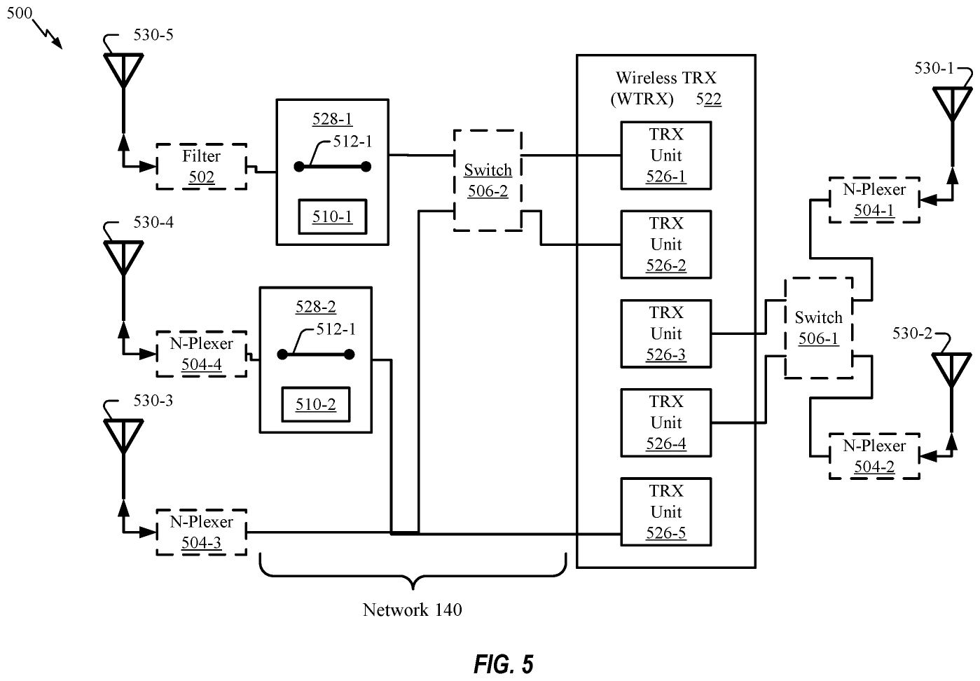

FIG. 5 illustrates a portion of an electronic device 500 having multiple antennas operating with multiple wireless protocols and including a first and second switched filter, in accordance with certain aspects of the present disclosure. The electronic device may be an example of the UE 104 of FIGS. 1 and 3. In addition to including the various components illustrated in FIG. 3, the electronic device 500 may further include the one or more components shown in FIG. 5. For example, the electronic device 500 may also include input/output ports (I/O ports) that enable data exchanges or interaction with other devices, networks, or users. The I/O ports may include serial ports (e.g., universal serial bus (USB) ports), parallel ports, audio ports, infrared (IR) ports, and so forth.

For communication purposes, the electronic device 500 also includes a wireless transceiver 522 coupled with a modem (not shown), a switched filter and controller 528, and one or more antennas 530-n. The wireless transceiver 522 provides connectivity to respective networks and other electronic devices connected therewith using radio-frequency (RF) wireless signals. Additionally or alternatively, the electronic device 500 may include a wired transceiver, such as an Ethernet or fiber optic interface for communicating over a personal or local network, an intranet, or the Internet.

The wireless transceiver 522 may facilitate communication over any suitable type of wireless network, such as a wireless local area network (LAN) (WLAN) such as Wi-Fi or Bluetooth (or an equivalent near-field communication network), a peer-to-peer (P2P) network, a mesh network, a cellular network, a wireless wide-area-network (WWAN) such as 3GPP2 LTE or 5G NR, a navigational network (e.g., the Global Positioning System (GPS) of North America or another Satellite Positioning System (SPS)), and/or a wireless personal-area-network (WPAN). In the context of the example environment 100, the wireless transceiver 522 enables the electronic device 500 to communicate with the base station 104 and networks connected therewith. Other figures referenced herein may pertain to other wireless networks.

The modem of the electronic device 500, such as a baseband modem, may be implemented as a system on-chip (SoC) that provides a digital communication interface for data, voice, messaging, and other applications of the electronic device 500. The modem may also include baseband circuitry to perform high-rate sampling processes that can include analog-to-digital conversion (ADC), digital-to-analog conversion (DAC), gain correction, skew correction, frequency translation, and so forth. The modem may also include logic to perform in-phase/quadrature (I/Q) operations, such as synthesis, encoding, modulation, demodulation, and decoding. More generally, the modem may be realized as a digital signal processor (DSP) or a processor that is configured to perform signal processing to support communications via one or more networks. Alternatively, ADC or DAC operations may be performed by a separate component or another illustrated component, such as the wireless transceiver 522.

The wireless transceiver 522 can include circuitry, logic, and other hardware for transmitting or receiving a wireless signal for at least one communication frequency band. In operation, the wireless transceiver 522 can implement at least one radio-frequency transceiver unit to process data and/or signals associated with communicating data of the electronic device 500 via the antenna 530. Generally, the wireless transceiver 522 can include filters, switches, amplifiers, and so forth for routing and processing signals that are transmitted or received via the antenna 530. As shown, the wireless transceiver 522 includes at least one converter unit (e.g., for ADC or DAC operations) and at least one transceiver (TRX) unit 526. But generally, the wireless transceiver 522 includes multiple transceiver units (e.g., for different wireless protocols such as WLAN versus WWAN or for supporting different frequency bands or frequency band combinations).

In some cases, components of the wireless transceiver 522, or a transceiver unit 526 thereof, are implemented as separate receiver and transmitter entities. Additionally or alternatively, the wireless transceiver 522 can be realized using multiple or different sections to implement respective receiving and transmitting operations (e.g., using separate transmit and receive chains). Example implementations of a transceiver unit 526 are described below. Further, example implementations of a switched filter 528 and a switched filter controller, including interactions with the wireless transceiver 522 and the associated modem, are described herein. At least a portion of the switched filter controller may be implemented by the modem. In addition, different wireless protocols such as WWAN and WLAN may be implemented on separate chips or as separate SoCs. As such, the blocks such as the modem and transceiver 522 may represent more than one modem or transceiver implemented either together on separate chips or separate SoCs.

In some implementations, there may be communication signals transmitted either between different transceiver units or between different modem segments to alert each other about communication events. For example, there may be high speed GPIO pins between a WWAN transceiver unit 526-1 and WLAN transceiver unit 526-n that may be referred to as coexistence pins. When one transceiver unit 526-n is becoming operational (e.g., about to transmit or about to receive in order to establish a channel or for other purposes), the coexistence pin may be used to send a signal alerting the other transceiver unit 526-n. The switched filter controller may receive signals on the coexistence pins to determine whether to switch between the bypass signal path and the filtered signal path based on the signals (e.g., RF path switch or selection). In this case, the switched filter controller is configured to selectively connect the transceiver unit 526-1 to the antenna 530 via the bypass signal path or via the filtered signal path based further on a signal from a second transceiver unit 526-n indicating a transmission or reception associated with a rejection band of the filter 510. For example, based on a signal from the coexistence pin from the WLAN transceiver unit 526-n, the switched filter controller may determine to switch to the filtered signal path in order to ensure the WLAN transceiver unit 526-1 is free of interference when transmitting or receiving a preliminary communication for establishing a channel. The coexistence pin may be faster than messaging between modems, which may have some latency.

As such, in general, the wireless communications apparatus may include a second transceiver unit 526-n and the switched filter controller is configured to cause the switching circuitry 202 to selectively connect the transceiver unit 526-1 to the antenna 530 via the bypass signal path or via the filtered signal path based further on information from the second transceiver unit 526-n. The information from the second transceiver unit 526-1, among other parameters may include information indicative of an operational frequency band of a second signal different than the carrier signal, or a location of a center frequency of the second signal within the operational frequency band, or a power level of the second signal, or some combination thereof.

An electronic device may have more than one switched filter 528. FIG. 5 illustrates a portion of an electronic device 500 having multiple antennas operating with multiple wireless protocols. As shown in FIG. 5, the electronic device 500 includes multiple antennas 530, at least one filter 502, at least one N-plexer 504, at least one switch 506, and at least one wireless transceiver 522, in addition to a first switched filter 528-1 and a second switched filter 528-2. Optional elements are shown with dashed lines. These components are interconnected using multiple electrically-conductive lines (e.g., wires or traces). As illustrated, the electronic device includes five antennas 530-1, 530-2, 530-3, 530-4, and 530-5. However, an electronic device 500 may have more or fewer antennas. Each respective antenna 530 is optionally coupled to a respective filter 502 or N-plexer 504. Thus, five total filters or N-plexers are coupled to the five antennas 530-1 . . . 530-5. N-plexers can include diplexers, triplexers, and so forth. An N-plexer can enable multiband antenna sharing with other modules that operate in different bands (e.g., 800 MHz, mid band (such as 1700-2200 MHz), and 5 GHz). To do so, each N-plexer includes two or more filter units configured to attenuate frequencies that are to be blocked from further propagation. Thus, a triplexer may include a high pass filter unit (e.g., for 5150-5925 MHz), a band-pass filter unit (e.g., for 3400-3800 MHZ), and a low-pass filter unit (e.g., for 1400-2680 MHz). Although not shown, a respective conductive line extends from each respective filter unit to another respective component, such as a switch 506 or transceiver unit 526.

Starting from the top right corner and moving clockwise, a first antenna 530-1 is coupled to a first N-plexer 504-1, and a second antenna 530-2 is coupled to a second N-plexer 504-2. A third antenna 530-3 is coupled to a third N-plexer 504-3, and a fourth antenna 530-4 is coupled to a fourth N-plexer 504-4. A fifth antenna 530-5 is optionally coupled to a filter 502. However, an electronic device may include fewer N-plexers or different number of filters or N-plexers, such as if an antenna 530 is associated with multiple filters or N-plexers. Here, each N-plexer 504 can be implemented using one or multiple filter units and corresponding filter paths extending from each filter unit. Each of the filter units can include, for example, a low pass filter, a high pass filter, or a bandpass filter.

The wireless transceiver 522 includes multiple transceiver units. Specifically, five transceiver units 526-1, 526-2, 526-3, 526-4, and 526-5 are shown. Each respective filter 502 or N-plexer 504 is coupled to at least one respective transceiver unit 526-1 to 526-5. Although five transceiver units 526-1 to 526-5 are shown, the wireless transceiver 522 can include a different number of transceiver units, such as if an antenna 530 and corresponding filter or N-plexer are coupled to more than one transceiver unit 526.

Thus, a network of conductive lines, additional filters or N-plexers, buffers, splitters, switches, and so forth can extend between the filter and N-plexers that are depicted and the multiple transceiver units 526-1 to 526-5 as indicated by network 512. Although the network 512 is only explicitly indicated “on the left” of the wireless transceiver 522, the network 512 may also include such components “on the right” of the wireless transceiver 522. Further, for clarity, additional details of this network 512 are omitted from FIG. 5. However, two switches are explicitly illustrated. A switch 506-1 is coupled between (i) the first N-plexer 504-1 and the second N-plexer 504-2 on one side and (ii) the third transceiver unit 526-3 and the fourth transceiver unit 526-4 on the other side. Also, a switch 506-2 is coupled between (i) the first switched filter 528 and the third N-plexer 504-3 on one side and (ii) the first transceiver unit 526-1 and the second transceiver unit 526-2 on the other side.

Different antennas can be useful for signal diversity, various signal frequencies, different communication technologies, implementing multiple-input multiple output (MIMO) processing for multiple streams, carrier aggregation (CA), beamforming from a particular side of an electronic device, and so forth.

As illustrated, the electronic device 500 includes a first switched filter 528-1 and a second switched filter 528-2. The first switched filter 528-1 is coupled between a first transceiver unit 526-1 and the fifth antenna 530-5. The second switched filter 528-2 is coupled between a fifth transceiver unit 526-5 and the fourth antenna 530-4. The different transceiver units 526-1 and 526-5 may be configured for different frequency bands (and/or different wireless protocols). Each switched filter 528-1 and 528-1 may operate similar to that described above, but each be configured with a filter 510 having a different frequency response (e.g., notch filters with different rejection bands). Each frequency response may be provided to selectively prevent interference with another band outside the band the respective transceiver unit 526 is operating.

As one example, the first transceiver unit 526-1 may be configured to transmit via a WWAN band (e.g., LTE B40 or NR N40) and the filter 510-1 in the first switched filter 528-1 may be configured with a rejection band covering a WLAN band (e.g., Wi-Fi 2.4 GHz). In this example, the fifth transceiver unit 526-5 may be configured to transmit in another WWAN band (e.g., N79) and the filter 510-2 in the second switched filter 528-2 may be configured with a rejection band covering another WLAN band (e.g., Wi-Fi 5 GHZ). Alternatively, the fifth transceiver unit 526-5 may be configured to transmit in a WLAN band (e.g., Wi-Fi 2.4 GHz) while the filter 510-2 in the second switched filter 528-2 may be configured with a rejection band covering a portion of a WWAN band (e.g., LTE B40 or NR N40). Other switched filters (not shown) may be provided as well for different coexistence scenarios.

In another example, a first transceiver unit 526-1 configured for the N79 band may have switched filter 528-1 with a filter 510-1 with a rejection band within a Wi-Fi band at 5 GHz. Likewise, a fifth transceiver unit 526-5 configured for 5 GHz Wi-Fi may have a switched filter 528-2 with a filter 510-2 that has a rejection band within N79 to avoid de-sensing receiving in the N79 band. A 2.4 GHz second harmonic may also de-sense receiving in the N79 band, so likewise a fifth transceiver unit 526-5 configured for 2 GHz Wi-Fi may have a switched filter 528-2 with a filter 510-2 that has a rejection band within the N79 band.

With reference to FIG. 5, in several scenarios above, the carrier signal is a transmitted signal via the transceiver unit 526-1 and the filter 510 protects an adjacent or other band different from the frequency band within which the carrier signal is operating. However, in other scenarios, the reverse may be true and the filter 510 may be provided to improve the ability to extract a receive signal received via the transceiver unit 526-1. For example, an LTE B40 or NR N40 receive signal may be saturated when in the adjacent 2.4 GHz band, Wi-Fi is transmitting and operating towards the upper end of the 2.4 GHz band. The switched filter controller may detect this scenario and cause the switching circuitry 202 to connect the antenna 530 to the transceiver unit 526-1 using the filtered signal path via the filter 510. This may increase the ability to receive the signal in the LTE B40 or NR N40 band. As LTE B40 or NR N40 may be operated in a time division duplexed (TDD) fashion, the switching circuitry 202 may be configured to toggle the one or more switches synchronously with the TDD cycle (e.g., if for LTE B40 or NR N40 transmission the switched filter is determined to use the bypass signal path but for LTE B40 or NR N40 reception the switched filter is determined to use the filtered signal path then the switching circuitry 202 may toggle the one or more switches synchronously with the TDD cycle between the bypass line 512 and the filter 510). Regardless, the switched filter 528 may be provided for different frequency bands in different scenarios for filtering for either a signal transmitted or received via the transceiver unit 526-1 connected to the switched filter or a signal passing through another transceiver unit 526-2.

### Overview of Adaptive Reception Diversity (ARD)

As noted above, ARD is a technique used in wireless communications to improve the quality and reliability of radio signal reception in adverse conditions, particularly in the presence of fading and interference. ARD involves dynamically adjusting the reception parameters of a wireless receiver (e.g., based on current channel conditions) to optimize device performance and signal reception quality and reliability. For example, in some cases, ARD may involve dynamically transitioning between a four receive antenna/port (4Rx) mode, a three receive antenna/port (3Rx) mode, a two receive antenna/port (2Rx) mode, and a one receive antenna/port (1Rx) mode.

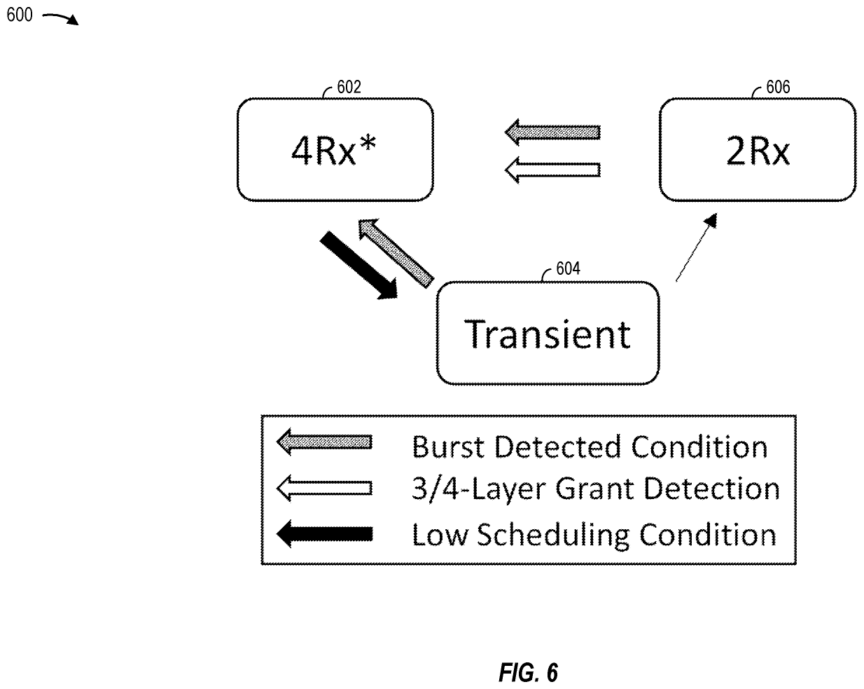

FIG. 6 depicts an example diagram 600 illustrating adaptive reception diversity (ARD). As illustrated, ARD may allow a UE to transition between a 4Rx mode 602, a transient state/mode 604, and a 2Rx mode 606, based on traffic conditions.

As illustrated for example, a UE may transition from 4Rx to Transient after detecting a low scheduling rate. A UE may receive/obtain/generate feedback while in a transient state. As illustrated, a UE may transition to 2Rx after the UE processes the feedback. As illustrated, a UE may transition to 4Rx from 2Rx based on Burst detection or continuous ¾L grant detection. In some cases, ARD may allow the UE to transition between additional modes (e.g., 1Rx mode and 3Rx mode).

### Aspects Related to Dynamic Adjustment of ARD

Aspects of the present disclosure provide apparatuses, methods, processing systems, and computer-readable mediums for dynamic adjustment of adaptive reception diversity (ARD).

As noted above, Adaptive Reception Diversity (ARD) generally refers to a technique used in wireless communications to improve the quality and reliability of radio signal reception in adverse conditions, particularly in the presence of fading and interference. ARD involves dynamically adjusting the reception parameters of a wireless receiver (e.g., based on current channel conditions) to optimize device performance and signal reception quality and reliability.

Unfortunately, in certain scenarios involving downlink and uplink CA, where FDD and TDD carriers share an antenna, TDD uplink SRS transmission may cause problems for FDD downlink reception. To overcome these problems, a UE may disable ARD and implement dynamic rank capping and reception de-sensing. However, when ARD is disabled, the UE may never transition to an optimal mode (e.g., to a 2Rx mode from a 4Rx mode), even when a greater quantity of receive antennas/ports is not beneficial, leading to excessive power consumption/waste.

Certain aspects of the present disclosure provide techniques for dynamic adjustment of ARD. For example, in some aspects, a UE may detect a conflict between resources allocated for receiving downlink signals (e.g., PDSCH) and resources allocated for transmitting SRS. In such cases, ARD may be dynamically adjusted (e.g., enabled, disabled, or mode switched) based on impacted FDD receive ports and/or the configuration of SRS on a TDD carrier.

Dynamically enabling/disabling ARD as described herein, based on conflict/impact (or lack thereof) and/or SRS configuration, may help to reduce power/energy consumption. The techniques disclosed herein may be particularly beneficial in multiple SIM (MSIM) scenarios, since power savings/gains may benefit each of the multiple SIMs (e.g., if they use higher order CA with TDD and FDD).

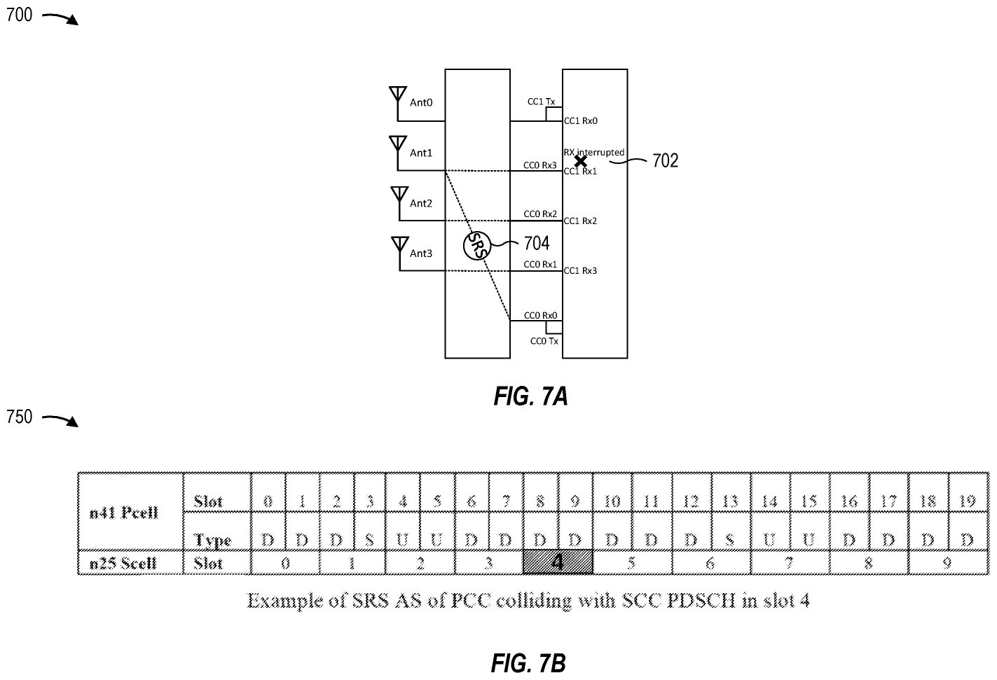

Applicability of dynamically enabling/disabling ARD as proposed herein may be understood with reference to FIGS. 7A and 7B that illustrate an example conflict between resources allocated for uplink transmission and downlink reception, in accordance with certain aspects of the present disclosure.

As illustrated in diagram 700 of FIG. 7A, for example, an apparatus (e.g., a UE) may have four antennas (Ant0, Ant1, Ant2, and Ant3) configured for reception of RF signals and/or transmission of RF signals.

As illustrated at 702, however, reception of signals (e.g., PDSCH) at certain antennas (e.g., Ant1 in this example) may be interrupted due to a conflict. As illustrated at 704, the conflict in this example is due to scheduled transmission of SRS using Ant1. Such a conflict may occur, for example, when transmission of SRS using a certain antennas occurs during a same time (e.g., during a same slot) as reception of PDSCH.

As illustrated in diagram 750 of FIG. 7B, a conflict between uplink transmission and downlink reception may occur when the uplink transmission and downlink reception are scheduled in a same slot, using a same antenna/port. The example in FIG. 7B illustrates such a conflict between antenna switching (AS) SRS and downlink reception of PDSCH scheduled in slot 4, using a same antenna/port.

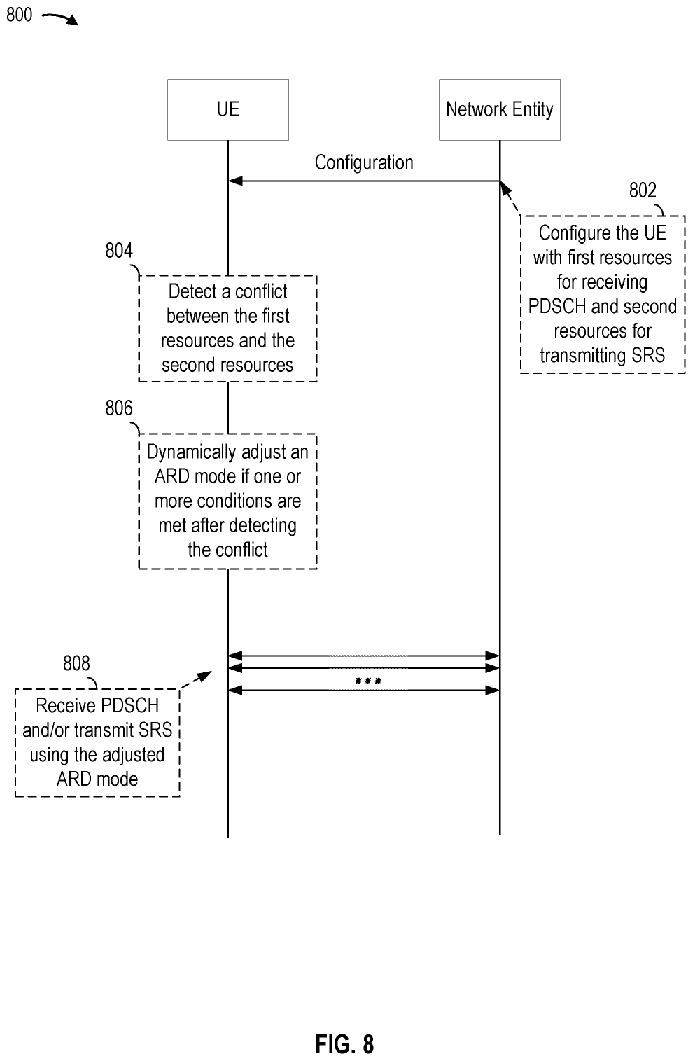

As noted above, certain aspects of the present disclosure provide techniques for dynamic adjustment of ARD. For example, in some aspects, a UE may detect a conflict between resources allocated for receiving downlink signals (e.g., PDSCH) and resources allocated for transmitting SRS. In such cases, ARD may be dynamically adjusted (e.g., enabled, disabled, or mode switched) based on impacted FDD receive ports and/or the configuration of SRS on a TDD carrier. These techniques may be understood with reference to FIG. 8, which depicts a call flow diagram 800 illustrating dynamic adjustment of ARD, in accordance with certain aspects of the present disclosure.

In some aspects, the UE shown in FIG. 8 may be an example of the UE 104 depicted and described with respect to FIGS. 1 and 3. In some aspects, the network entity shown in FIG. 8 may be an example of the BS 102 (e.g., a gNB) depicted and described with respect to FIGS. 1 and 3 or a disaggregated base station depicted and described with respect to FIG. 2.

As illustrated at 802, the UE may be configured with first resources for receiving downlink signal(s) (e.g., PDSCH) and second resources for transmitting uplink signal(s) (e.g., SRS).

As illustrated at 804, the UE may detect a conflict (e.g., such as the conflict described above with reference to FIG. 7) between the first resources and the second resources. As illustrated at 806, the UE may dynamically adjust an ARD mode if one or more conditions are met after detecting the conflict.

As illustrated at 808, the UE may receive PDSCH and/or transmit SRS using the adjusted ARD mode.

As noted above, certain aspects of the present disclosure provide techniques for a UE to dynamically adjust (e.g., enable, disable, or mode switch) ARD based on impacted FDD receive ports/antennas and/or TDD carrier SRS configuration (e.g., whether SRS is periodically, semi-persistently, or aperiodically scheduled).

In some aspects, for example, a UE may detect a conflict between one or more ports/antennas used for FDD reception and TDD transmission based on RRC over-the-air (OTA) and RF configuration. The network is typically free to schedule downlink transmissions on both the FDD and TDD carriers. However, in some cases, the network may not schedule any downlink transmissions on the FDD carrier when there is a conflict with uplink SRS transmission on the TDD carrier.

According to certain aspects of the present disclosure, ARD may be enabled at a UE when there is no conflict between the UE's TDD SRS transmission and FDD DL reception. In some aspects, when scheduling is changed such that TDD SRS transmission has an impact on FDD downlink reception, the UE may disable ARD. In some aspects, the UE may wait/monitor for a certain duration before disabling ARD, in an effort to ensure that the impact is observed for a threshold duration (e.g., and to avoid rapid switching or “ping-ponging”). For example, the UE may monitor a scheduling pattern of the FDD DL transmissions (reception at the UE) and the TDD SRS transmissions to determine if the scheduling pattern will result in an impact for a threshold duration (e.g., X ms) which may be configurable. The duration of the impact (e.g., on a particular impacted/conflict slot) may inform ARD adjustment (e.g., enable and disable) decisions on that impacted slot.

For example, if a UE is currently operating with 4 active receive ports/antennas (4Rx), and if scheduled TDD uplink SRS transmission impacts 2 FDD downlink receive ports/antennas (e.g., for a threshold duration), the UE may enable ARD and directly transition to 2Rx (e.g., disable 2 of the 4 active receive ports/antennas). Doing so may allow the UE to report rank 2 in uplink. In some cases, a same monitoring pattern window threshold of X ms (e.g., or a different threshold Y ms) may be applied here to avoid rapid switching or ping-ponging.

In some aspects, if receive chains are changed/adjusted frequently due to ASDIV operations, ARD may be disabled to estimate better receive and transmit chains, allowing the UE to avoid/mitigate unwanted impact on FDD reception.

As noted above, in some cases, the SRS configuration on the TDD carrier may be periodic, semi-persistent (e.g., the network may activate or deactivate dynamically), or aperiodic. Disabling ARD (e.g., statically) without considering SRS configuration may also lead to excessive power consumption/waste.

According to certain aspects of the present disclosure, a UE may detect the nature (e.g., the scheduling pattern) of the SRS configuration configured on a TDD carrier. For example, the UE may determine that SRS is periodically, semi-persistently, or aperiodically configured/scheduled, and the UE may make ARD adjustment decisions based on the determination.

For example, in some aspects, when a UE determines that SRS is periodically configured/scheduled, the UE may disable ARD based on a conflict/impact, as described above. In some aspects, when a UE determines that SRS is semi-persistently configured/scheduled, the UE may disable ARD based on activation of the semi-persistent (SP) SRS and/or conflict/impact. For example, when the network activates SP SRS, the UE may keep ARD in an enabled state (or may enable ARD if disabled). If SP SRS conflicts with downlink FDD reception (as described above), the UE may decide to disable/enable ARD and/or keep ARD in the disabled/enabled state until the conflict is resolved, or until SRS AS is deactivated (e.g., via MAC-CE).

In some cases, a same X ms duration threshold may be used once SP SRS is activated to avoid any ping-ponging. This threshold may be applicable, for example, when the downlink signal (e.g., PDSCH) and/or the uplink signal (e.g., SRS) are associated with multiple subscriber identity modules (MSIMs).

In some aspects, when a UE determines that SRS is configured/scheduled on an aperiodic basis, the UE may allow ARD to continue to be disabled (or may disable ARD), and the UE may remain in a 4Rx mode.

The UE may consider the configuration/scheduling of SRS when making ARD adjustment decisions on a per-cell and/or a per-bandwidth part (BWP) basis, for example, when the UE has received 4 L grants for a reduced BWP. In scenarios where the UE is RRC configured with 2-layer (2 L) grants in a BWP, then ARD may be disabled based on collision/conflict/impact and/or SRS configuration/scheduling.

When 2 receive ports/antennas are impacted due to reception de-sensing on a mid-band FDD carrier, a UE may enable reporting rank 2 and enable ARD to transition to 2Rx immediately in order to reduce power/energy consumption (e.g., in cases with 4 enabled receive ports/antennas and 2 or 1 enabled transmit ports/antennas (2T4R and 1T4R respectively)).

When one receive port/antenna is impacted due to reception de-sensing on a mid-band FDD carrier, a UE may dynamically enable ARD if scheduling is low from the network. In such cases, after the UE dynamically enables ARD, the UE may transition to 2Rx instead of requesting/using 3-layer (3 L) grants. The UE may use a rank capping algorithm, and may report rank 3 in order to reduce power/energy consumption. In other words, the UE may transition from 3Rx to 2Rx, and then may transition back to 3Rx when the UE is configured with enough grants from the network.

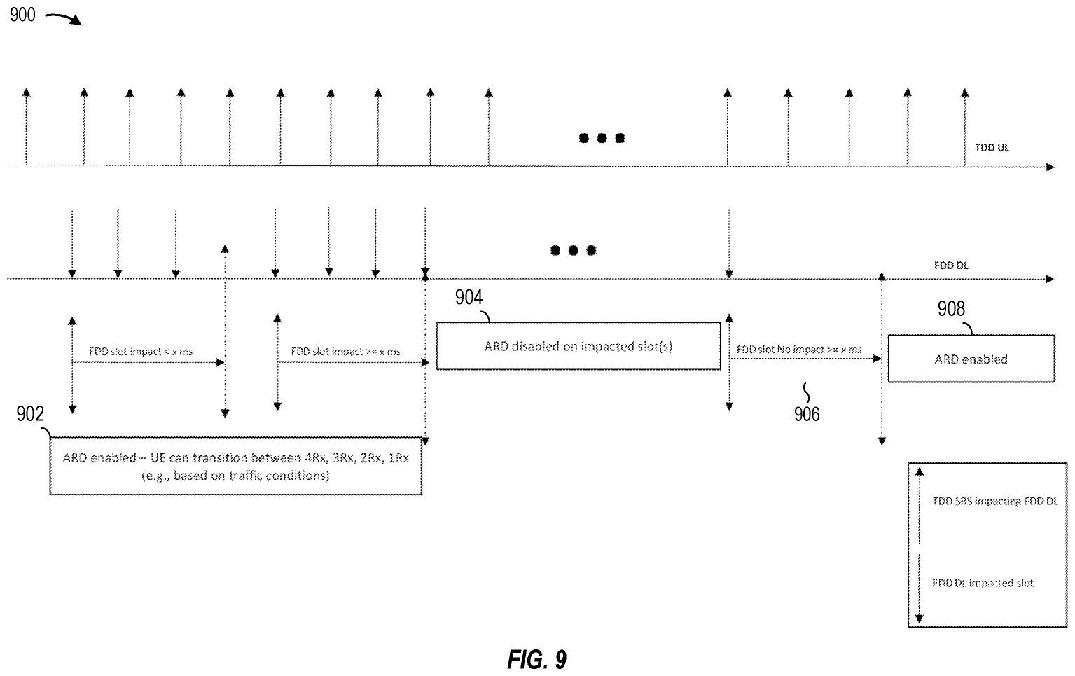

FIG. 9 depicts an example timing diagram 900 illustrating dynamic adjustment of ARD, in accordance with certain aspects of the present disclosure.

As illustrated, a UE may be transmitting SRS on a TDD carrier, and may be receiving downlink signals (e.g., PDSCH) on an FDD carrier. As illustrated, the SRS transmission may impact the PDSCH reception.

As illustrated at 902, the UE may have ARD enabled, allowing the UE to transition between a 4Rx mode, a 3Rx mode, a 2Rx mode, and a 1Rx mode (e.g., based on traffic conditions). As illustrated, the UE may detect that an FDD slot impact does not meet or exceed a threshold X ms. The UE may, thus, remain in an ARD enabled state.

As illustrated at 904, however, after the UE detects that an FDD slot impact does meet or exceed the threshold X ms, the UE may disable ARD for a duration including the impacted slot(s).

The UE may continue monitoring/measuring/detecting the FDD slot impact after ARD is disabled on the impacted slot(s). As illustrated at 906, the UE may detect that the FDD slot does not have an impact that meets or exceeds the threshold X ms. As illustrated at 908, the UE may enable ARD based on the detection.

Dynamically enabling/disabling ARD as described herein may help to reduce power/energy consumption, particularly in MSIM scenarios, where power savings/gains may benefit each SIM if they use higher order CA with TDD and FDD.

### Example Operations

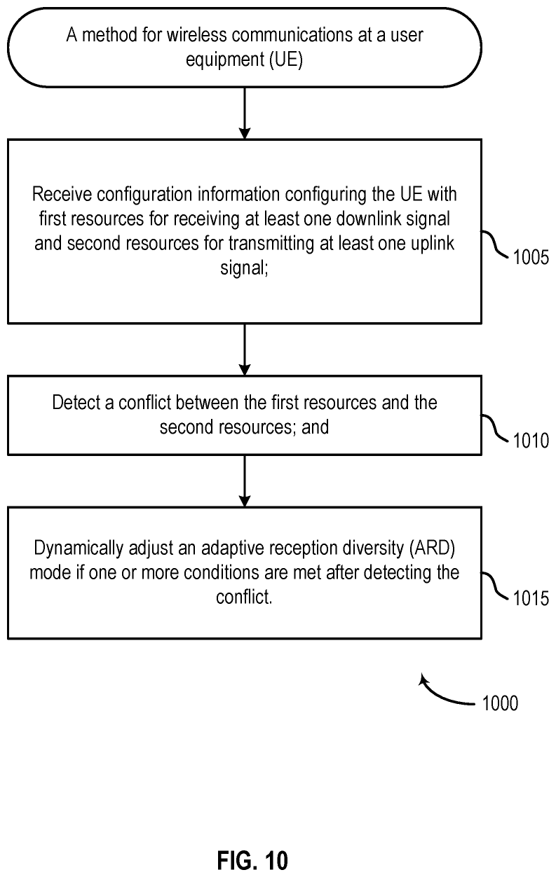

FIG. 10 shows an example of a method 1000 of wireless communications at a user equipment (UE), such as a UE 104 of FIGS. 1 and 3.

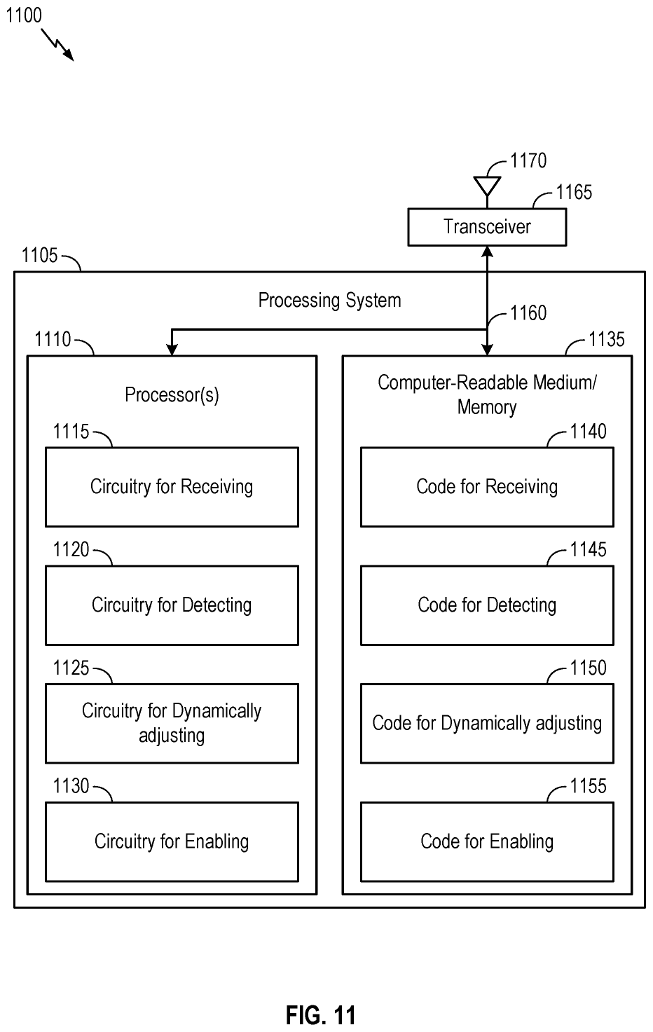

Method 1000 begins at step 1005 with receiving configuration information configuring the UE with first resources for receiving at least one downlink signal and second resources for transmitting at least one uplink signal. In some cases, the operations of this step refer to, or may be performed by, circuitry for receiving and/or code for receiving as described with reference to FIG. 11.

Method 1000 then proceeds to step 1010 with detecting a conflict between the first resources and the second resources. In some cases, the operations of this step refer to, or may be performed by, circuitry for detecting and/or code for detecting as described with reference to FIG. 11.

Method 1000 then proceeds to step 1015 with dynamically adjusting an adaptive reception diversity (ARD) mode if one or more conditions are met after detecting the conflict. In some cases, the operations of this step refer to, or may be performed by, circuitry for dynamically adjusting and/or code for dynamically adjusting as described with reference to FIG. 11.

In some aspects, the one or more conditions relate to whether the conflict is detected for a threshold time duration.

In some aspects, the one or more conditions relate to at least one of: a capability of the UE to adjust the ARD mode; a configuration of the at least one uplink signal; or whether the ARD mode is enabled or disabled.

In some aspects, dynamically adjusting the ARD mode comprises disabling the ARD mode based on detecting the conflict.

In some aspects, the method 1000 further includes enabling the ARD mode if the conflict is not detected. In some cases, the operations of this step refer to, or may be performed by, circuitry for enabling and/or code for enabling as described with reference to FIG. 11.

In some aspects, dynamically adjusting the ARD mode comprises at least one of: adjusting a first quantity of antennas utilized by the UE for receiving the at least one downlink signal; or adjusting a second quantity of antennas utilized by the UE for transmitting the at least one uplink signal.

In some aspects, one of the first quantity of antennas and one of the second quantity of antennas are shared by a common radio frequency (RF) front end.

In some aspects, the uplink signal comprises a sounding reference signal (SRS).

In some aspects, the SRS is transmitted periodically, aperiodically, or semi-persistently.

In some aspects, the downlink signal comprises a physical downlink shared channel (PDSCH) transmission.

In some aspects, the first resources are configured for a frequency division duplexing (FDD) mode; and the second resources are configured for a time division duplexing (TDD) mode.

In some aspects, the first resources and the second resources comprise time and frequency resources.

In some aspects, the downlink signal and the uplink signal are associated with multiple subscriber identity modules (SIMs).

In one aspect, method 1000, or any aspect related to it, may be performed by an apparatus, such as communications device 1100 of FIG. 11, which includes various components operable, configured, or adapted to perform the method 1000. Communications device 1100 is described below in further detail.

Note that FIG. 10 is just one example of a method, and other methods including fewer, additional, or alternative steps are possible consistent with this disclosure.

### Example Communications Device(s)

FIG. 11 depicts aspects of an example communications device 1100. In some aspects, communications device 1100 is a user equipment, such as UE 104 described above with respect to FIGS. 1 and 3.

The communications device 1100 includes a processing system 1105 coupled to the transceiver 1165 (e.g., a transmitter and/or a receiver). The transceiver 1165 is configured to transmit and receive signals for the communications device 1100 via the antenna 1170, such as the various signals as described herein. The processing system 1105 may be configured to perform processing functions for the communications device 1100, including processing signals received and/or to be transmitted by the communications device 1100.

The processing system 1105 includes one or more processors 1110. In various aspects, the one or more processors 1110 may be representative of one or more of receive processor 358, transmit processor 364, TX MIMO processor 366, and/or controller/processor 380, as described with respect to FIG. 3. The one or more processors 1110 are coupled to a computer-readable medium/memory 1135 via a bus 1160. In certain aspects, the computer-readable medium/memory 1135 is configured to store instructions (e.g., computer-executable code) that when executed by the one or more processors 1110, cause the one or more processors 1110 to perform the method 1000 described with respect to FIG. 10, or any aspect related to it. Note that reference to a processor performing a function of communications device 1100 may include one or more processors 1110 performing that function of communications device 1100.

In the depicted example, computer-readable medium/memory 1135 stores code (e.g., executable instructions), such as code for receiving 1140, code for detecting 1145, code for dynamically adjusting 1150, and code for enabling 1155. Processing of the code for receiving 1140, code for detecting 1145, code for dynamically adjusting 1150, and code for enabling 1155 may cause the communications device 1100 to perform the method 1000 described with respect to FIG. 10, or any aspect related to it.

The one or more processors 1110 include circuitry configured to implement (e.g., execute) the code stored in the computer-readable medium/memory 1135, including circuitry such as circuitry for receiving 1115, circuitry for detecting 1120, circuitry for dynamically adjusting 1125, and circuitry for enabling 1130. Processing with circuitry for receiving 1115, circuitry for detecting 1120, circuitry for dynamically adjusting 1125, and circuitry for enabling 1130 may cause the communications device 1100 to perform the method 1000 described with respect to FIG. 10, or any aspect related to it.

Various components of the communications device 1100 may provide means for performing the method 1000 described with respect to FIG. 10, or any aspect related to it. For example, means for transmitting, sending or outputting for transmission may include transceivers 354 and/or antenna(s) 352 of the UE 104 illustrated in FIG. 3 and/or the transceiver 1165 and the antenna 1170 of the communications device 1100 in FIG. 11. Means for receiving or obtaining may include transceivers 354 and/or antenna(s) 352 of the UE 104 illustrated in FIG. 3 and/or the transceiver 1165 and the antenna 1170 of the communications device 1100 in FIG. 11.

### Example Clauses

Implementation examples are described in the following numbered clauses:

Clause 1: A method for wireless communications at a user equipment (UE), comprising: receiving configuration information configuring the UE with first resources for receiving at least one downlink signal and second resources for transmitting at least one uplink signal; detecting a conflict between the first resources and the second resources; and dynamically adjusting an adaptive reception diversity (ARD) mode if one or more conditions are met after detecting the conflict.

Clause 2: The method of Clause 1, wherein the one or more conditions are based on whether the conflict is detected for a threshold time duration.

Clause 3: The method of Clause 2, wherein the one or more conditions are based on at least one of: a capability of the UE to adjust the ARD mode; a configuration of the at least one uplink signal; or whether the ARD mode is enabled or disabled.

Clause 4: The method of any one of Clauses 1-3, wherein dynamically adjusting the ARD mode comprises disabling the ARD mode based on detecting the conflict.

Clause 5: The method of Clause 4, further comprising enabling the ARD mode if the conflict is not detected.

Clause 6: The method of any one of Clauses 1-5, wherein dynamically adjusting the ARD mode comprises at least one of: adjusting a first quantity of antennas utilized by the UE for receiving the at least one downlink signal; or adjusting a second quantity of antennas utilized by the UE for transmitting the at least one uplink signal.

Clause 7: The method of Clause 6, wherein one of the first quantity of antennas and one of the second quantity of antennas are shared by a common radio frequency (RF) front end.

Clause 8: The method of any one of Clauses 1-7, wherein the uplink signal comprises a sounding reference signal (SRS).

Clause 9: The method of Clause 8, wherein the SRS is transmitted periodically, aperiodically, or semi-persistently.

Clause 10: The method of any one of Clauses 1-9, wherein the downlink signal comprises a physical downlink shared channel (PDSCH) transmission.

Clause 11: The method of any one of Clauses 1-10, wherein: the first resources are configured for a frequency division duplexing (FDD) mode; and the second resources are configured for a time division duplexing (TDD) mode.

Clause 12: The method of any one of Clauses 1-11, wherein the first resources and the second resources comprise time and frequency resources.

Clause 13: The method of any one of Clauses 1-12, wherein the downlink signal and the uplink signal are associated with multiple subscriber identity modules (SIMs).

Clause 14: An apparatus, comprising: a memory comprising executable instructions; and a processor configured to execute the executable instructions and cause the apparatus to perform a method in accordance with any one of Clauses 1-13.

Clause 15: An apparatus, comprising means for performing a method in accordance with any one of Clauses 1-13.

Clause 16: A non-transitory computer-readable medium comprising executable instructions that, when executed by a processor of an apparatus, cause the apparatus to perform a method in accordance with any one of Clauses 1-13.

Clause 17: A computer program product embodied on a computer-readable storage medium comprising code for performing a method in accordance with any one of Clauses 1-13.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, “a processor,” “at least one processor” or “one or more processors” generally refers to a single processor configured to perform one or multiple operations or multiple processors configured to collectively perform one or more operations. In the case of multiple processors, performance of the one or more operations could be divided amongst different processors, though one processor may perform multiple operations, and multiple processors could collectively perform a single operation. Similarly, “a memory,” “at least one memory” or “one or more memories” generally refers to a single memory configured to store data and/or instructions, multiple memories configured to collectively store data and/or instructions.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. An apparatus for wireless communication at a user equipment (UE), comprising:
at least one memory comprising computer-executable instructions; and
one or more processors, individually or collectively, configured to execute the computer-executable instructions and cause the UE to:
receive configuration information configuring the UE with first resources for receiving at least one downlink signal and second resources for transmitting at least one uplink signal;
detect a conflict between the first resources and the second resources; and
dynamically adjust an adaptive reception diversity (ARD) mode if one or more conditions are met after detecting the conflict.

2. The apparatus of claim 1, wherein the one or more conditions are based on whether the conflict is detected for a threshold time duration.

3. The apparatus of claim 2, wherein the one or more conditions are based on at least one of: a capability of the UE to adjust the ARD mode; a configuration of the at least one uplink signal; or whether the ARD mode is enabled or disabled.

4. The apparatus of claim 1, wherein in order to dynamically adjust the ARD mode, the one or more processors, individually or collectively, are further configured to cause the UE to disable the ARD mode based on detecting the conflict.

5. The apparatus of claim 4, wherein the one or more processors are further configured to cause the UE to enable the ARD mode if the conflict is not detected.

6. The apparatus of claim 1, wherein in order to dynamically adjust the ARD mode, the one or more processors, individually or collectively, are further configured to cause the UE to at least one of: adjust a first quantity of antennas utilized by the UE for receiving the at least one downlink signal; or adjust a second quantity of antennas utilized by the UE for transmitting the at least one uplink signal.

7. The apparatus of claim 6, wherein one of the first quantity of antennas and one of the second quantity of antennas are shared by a common radio frequency (RF) front end.

8. The apparatus of claim 1, wherein the uplink signal comprises a sounding reference signal (SRS).

9. The apparatus of claim 8, wherein the SRS is transmitted periodically, aperiodically, or semi-persistently.

10. The apparatus of claim 1, wherein the downlink signal comprises a physical downlink shared channel (PDSCH) transmission.

11. The apparatus of claim 1, wherein: the first resources are configured for a frequency division duplexing (FDD) mode; and the second resources are configured for a time division duplexing (TDD) mode.

12. The apparatus of claim 1, wherein the first resources and the second resources comprise time and frequency resources.

13. The apparatus of claim 1, wherein the downlink signal and the uplink signal are associated with multiple subscriber identity modules (SIMs).

14. A method for wireless communications at a user equipment (UE), comprising:
receiving configuration information configuring the UE with first resources for receiving at least one downlink signal and second resources for transmitting at least one uplink signal;
detecting a conflict between the first resources and the second resources; and
dynamically adjusting an adaptive reception diversity (ARD) mode if one or more conditions are met after detecting the conflict.

15. The method of claim 14, wherein the one or more conditions are based on whether the conflict is detected for a threshold time duration.

16. The method of claim 15, wherein the one or more conditions are based on at least one of: a capability of the UE to adjust the ARD mode; a configuration of the at least one uplink signal; or whether the ARD mode is enabled or disabled.

17. The method of claim 14, wherein dynamically adjusting the ARD mode comprises disabling the ARD mode based on detecting the conflict.

18. The method of claim 17, further comprising enabling the ARD mode if the conflict is not detected.

19. The method of claim 14, wherein dynamically adjusting the ARD mode comprises at least one of: adjusting a first quantity of antennas utilized by the UE for receiving the at least one downlink signal; or adjusting a second quantity of antennas utilized by the UE for transmitting the at least one uplink signal.

20. The method of claim 19, wherein one of the first quantity of antennas and one of the second quantity of antennas are shared by a common radio frequency (RF) front end.

21. The method of claim 14, wherein the uplink signal comprises a sounding reference signal (SRS).

22. The method of claim 21, wherein the SRS is transmitted periodically, aperiodically, or semi-persistently.

23. The method of claim 14, wherein the downlink signal comprises a physical downlink shared channel (PDSCH) transmission.

24. The method of claim 14, wherein: the first resources are configured for a frequency division duplexing (FDD) mode; and the second resources are configured for a time division duplexing (TDD) mode.

25. The method of claim 14, wherein the first resources and the second resources comprise time and frequency resources.

26. The method of claim 14, wherein the downlink signal and the uplink signal are associated with multiple subscriber identity modules (SIMs).

27. A computer readable medium at a user equipment (UE) having instructions stored thereon which, when executed by one or more processors, individually or collectively, cause the UE to:
receive configuration information configuring the UE with first resources for receiving at least one downlink signal and second resources for transmitting at least one uplink signal;
detect a conflict between the first resources and the second resources; and
dynamically adjust an adaptive reception diversity (ARD) mode if one or more conditions are met after detecting the conflict.

28. An apparatus for wireless communication at a user equipment (UE), comprising:
means for receiving configuration information configuring the UE with first resources for receiving at least one downlink signal and second resources for transmitting at least one uplink signal;
means for detecting a conflict between the first resources and the second resources; and
means for dynamically adjusting an adaptive reception diversity (ARD) mode if one or more conditions are met after detecting the conflict.
